(19) United States
(12) Patent Application Publication
(10) Pub. No.: US 2014/0078060 A1
(43) Pub. Date: Mar. 20, 2014

(54) INPUT DEVICE AND ELECTRONIC DEVICE

(71) Applicant: Quanta Computer Inc., Kuei Shan Hsiang (TW)

(72) Inventors: Chee-Chun Leung, Kuei Shan Hsiang (TW); Yun-Cheng Liu, Kuei Shan Hsiang (TW); Kuan-Chun Hsieh, Kuei Shan Hsiang (TW); Chien-Hung Lin, Kuei Shan Hsiang (TW)

(73) Assignee: Quanta Computer Inc., Kuei Shan Hsiang (TW)

(21) Appl. No.: 13/948,003

(22) Filed: Jul. 22, 2013

(30) Foreign Application Priority Data
Sep. 18, 2012 (TW) 101134090

(51) Int. Cl. G06F 3/0338

(52) U.S. Cl. CPC G06F 3/0338
USPC 345/161

(57) ABSTRACT

An input device is equipped with a cursor pointing unit including a mechanical control stick and an optical sensor. The optical sensor is mounted on the mechanical control stick and has a contact surface for sensing object motion thereon. A cursor signal is generated when the mechanical control stick is inclined by an exerted pressure. When the mechanical control stick is not inclined, a position frame of the object on the contact surface is retrieved as a reference frame. A real-time position frame of the object is retrieved when the object remains on the contact surface. A speed of the object is calculated according to the reference frame and the real-time position frame. When the speed does not exceed a threshold, a cursor position move is generated according to the speed; and when the speed exceeds the threshold, a switch signal is generated to initiate a gesture controlling mode.

### CROSS REFERENCE TO RELATED APPLICATIONS

This application claims priority of Taiwan Patent Application Ser. No. 101134090, filed 2012 Sep. 18, entitled INPUT DEVICE AND ELECTRONIC DEVICE. The contents of this application are hereby incorporated by reference.

### BACKGROUND OF THE INVENTION

1. Field of the Invention

The disclosure relates generally to a computer input device, and in particular to a cursor pointing device of a laptop computer or similar device.

2. Description of the Related Art

A general laptop computer is equipped with a touchpad or trackpoint pointing device as a pointing device, and thereby, obviating a separate mouse.

When using a conventional touchpad, a user has to move his hand from a keyboard to the touchpad. Moving user's hand causes inconvenient and time wasting. In addition, excessive using of touchpad may make a coarse finger tip for a user.

The trackpoint pointing device may cause problems different from the touchpad. A conventional trackpoint pointing device is a mechanical pointing device. It is difficult to make a tiny cursor motion using the trackpoint pointing device. In addition, excessive using of trackpoint pointing device may cause finger fatigue. Furthermore, it is difficult to define control gesture using the conventional mechanical trackpoint pointing device.

Accordingly, there is a need for more user-friendly cursor pointing device that enables convenient cursor control and enables a user gesture.

### BRIEF SUMMARY OF INVENTION

The disclosed device is a cursor pointing device associated with a laptop computer or similar device.

According to a first aspect of the invention, an input device is provided. The input device comprises a key unit and a cursor pointing unit. The key unit comprises a plurality of keys. The cursor pointing unit comprises a mechanical control stick, an optical sensor and a controlling unit. The mechanical control stick comprises an upper end and a lower end, wherein the lower end is attached to the key unit. The optical sensor is mounted on the upper end of the mechanical control stick, wherein the optical sensor has a contact surface for sensing object motion thereon. The controlling unit configured to perform steps of: upon detecting an object on the contact surface, determining whether the mechanical control stick is inclined by an exerted pressure; generating a cursor signal when the mechanical control stick is inclined by an exerted pressure; when the mechanical control stick is not inclined, retrieving a position frame of the object on the contact surface as a reference frame, and retrieving a real-time position frame of the object when the object remains on the contact surface; calculating a speed of the object according to the reference frame and the real-time position frame; when the speed does not exceed a threshold, generating a cursor position move according to the speed; and when the speed exceeds the threshold, generating a switch signal to initiate a gesture controlling mode.

In accordance with some embodiments, the controlling unit determines and outputs a cursor movement signal when the mechanical control stick is inclined by an exerted pressure.

In accordance with some embodiments, the mechanical control stick is used for executing fast and long-distance cursor movement; and the optical sensor is used for executing fine cursor movement.

In accordance with some embodiments, the controlling unit directs a screen to show a different page when the speed of the object exceeds the threshold.

In accordance with some embodiments, upon detecting the object on the contact surface and receiving a scancode corresponding to a key being pressed, the controlling unit receives a click signal corresponding to the scancode.

In accordance with some embodiments, the controlling unit receives a click signal when a downward vertical pressure is exerted on the cursor pointing unit.

According to a second aspect of the invention, a portable electronic device is provided. The portable electronic device comprises a keyboard device, a screen device and a computing device. The keyboard device comprises a key unit and a cursor pointing unit. The key unit comprises a plurality of keys. The cursor pointing unit comprises a mechanical control stick and an optical sensor. The mechanical control stick comprises an upper end and a lower end, the lower end is attached to the keyboard. The optical sensor is mounted on the upper end of the mechanical control stick and has a contact surface for sensing object motion thereon. The computing device configured to perform steps of: upon detecting an object on the contact surface, determining whether the mechanical control stick is inclined by an exerted pressure; generating a cursor signal when the mechanical control stick is inclined by an exerted pressure; when the mechanical control stick is not inclined, retrieving a position frame of the object on the contact surface as a reference frame, and retrieving a real-time position frame of the object when the object remains on the contact surface; calculating a speed of the object according to the reference frame and the real-time position frame; when the speed does not exceed a threshold, generating a cursor position move according to the speed; and when the speed exceeds the threshold, generating a switch signal to initiate a gesture controlling mode.

### BRIEF DESCRIPTION OF DRAWINGS

The invention can be more fully understood by reading the subsequent detailed description and examples with references made to the accompanying drawings, wherein:

FIG. 1 is a front view of a laptop computer according to an exemplary embodiment;

FIG. 2 is a cross-sectional diagram of a cursor pointing unit according to an exemplary embodiment;

FIG. 3 is a cross-sectional diagram of a cursor pointing unit according to an exemplary embodiment;

FIG. 4A and FIG. 4B illustrate a flowchart of a method according to an exemplary embodiment.

### DETAILED DESCRIPTION OF INVENTION

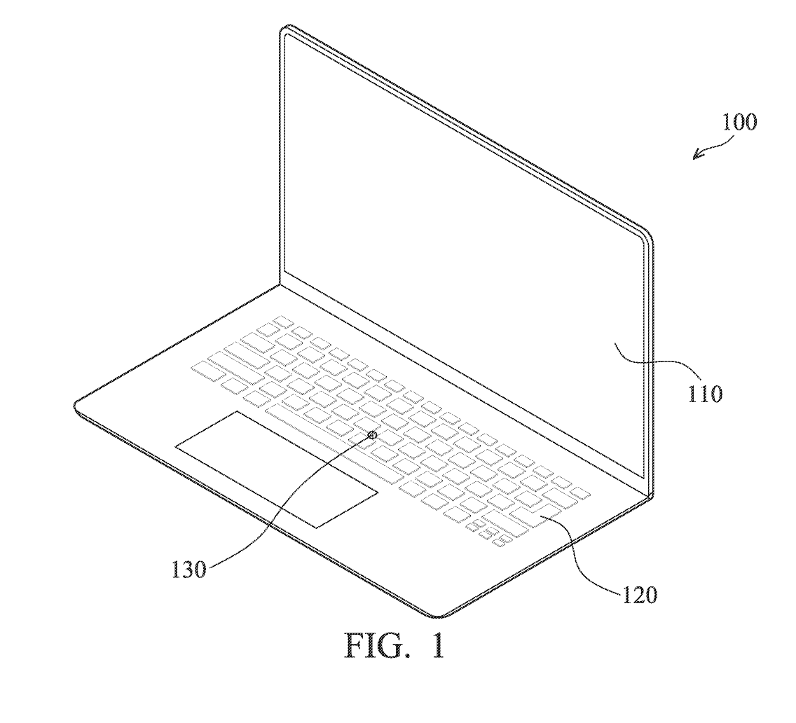

FIG. 1 is a front view of a laptop computer according to an exemplary embodiment. Referring to FIG. 1, a laptop computer is illustrated as an example. However, it will be appreciated, in light of the following disclosure, that the invention may be practiced on electronic devices other than such laptop computer. The input device of the present invention can be used in various electronic devices.

Referring to FIG. 1, an embodiment of a laptop computer 100 primarily comprises a screen 110, key unit 120 and cursor pointing unit 130.

The screen 110 may be a general monitor without touch control function.

The key unit 120 can be a general QWERTY keyboard, which is pivotally connected with screen 110 via a pivot. For example, keys include the normal 26 keys bearing the letters of the alphabet, which are arranged in the conventional QWERTY layout. The keys also include conventional F1 through F12 function keys, and other keys such as CAPS LOCK, SHIFT, TAB, and so forth.

The cursor pointing unit 130 is mounted at the lower end to the key unit 120, between the keys of key unit 120. For example, the cursor pointing unit 130 can be mounted between keys ‘G’, ‘H’, and ‘B’.

The cursor pointing unit 130 comprises mechanical and optical components for controlling cursor movements according to user manipulation, such as touch or pressure exertion on the cursor pointing unit 130. Structures of cursor pointing unit 130 is disclosed below.

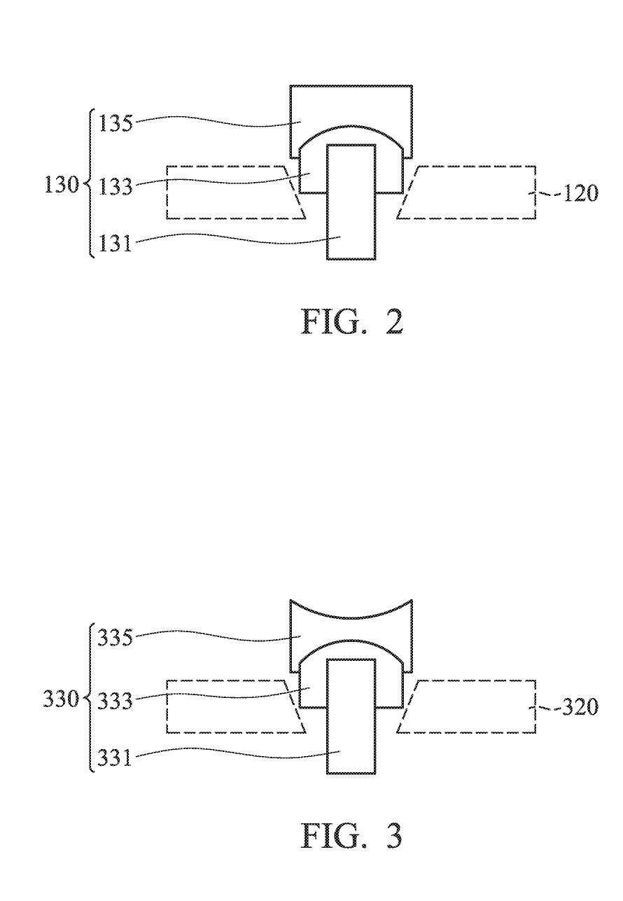

FIG. 2 is a schematic diagram of a cursor pointing unit according to an exemplary embodiment. Referring to FIG. 2, a sectional view of the cursor pointing unit in FIG. 1 is illustrated. In FIG. 2, components which have been illustrated in FIG. 1 are marked by the same numbers as in FIG. 1.

The cursor pointing unit 130 comprises a mechanical control stick 131, a buffer cap 133 and an optical sensor 135.

A lower end of the mechanical control stick 131, i.e., a lower part of the mechanical control stick 131 in FIG. 2, is attached to a keyboard device (not shown); the buffer cap 133 is mounted an upper end of the mechanical control stick 131; and the optical sensor 135 is attached to the buffer cap 133. The mechanical control stick 131 is used for receiving pressure exerted by a user, and translating the pressure exerted thereon into a command to move a cursor on a screen.

The optical sensor 135 has a contact surface for sensing object motion thereon, such as finger motion on the contact surface. The optical sensor 135 directs cursor movement on a screen according to the detected finger motion.

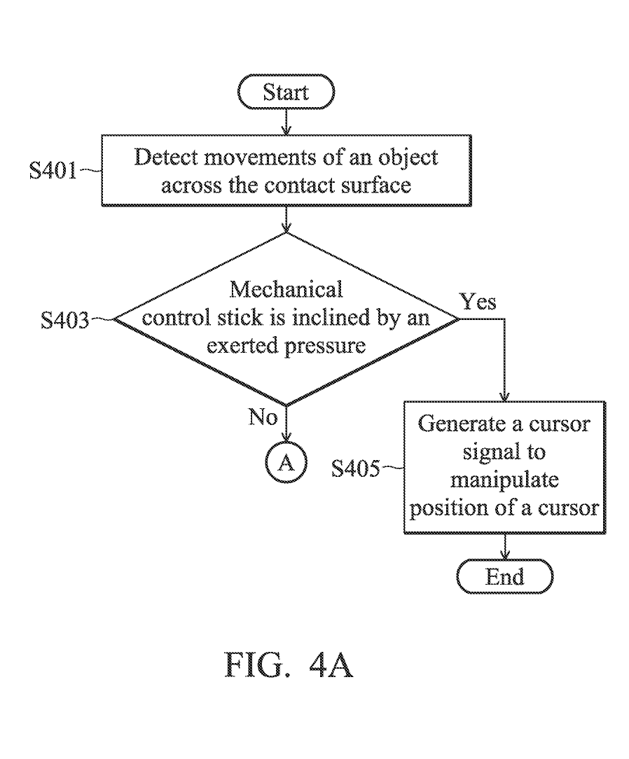

The contact surface can have a flat surface (as shown in FIG. 2) or a recessed surface (as shown in FIG. 3).

The cursor pointing unit 330 illustrated in FIG. 3 is similar to the cursor pointing unit 130 of FIG. 2, except that the contact surface of the cursor pointing unit 330 is a recessed surface. The recess on the cursor pointing unit 330 enables a typist to locate the optical sensor 335. The recess on the optical sensor 335 can be defined as a circular recess having a radius longer than a side of a key, for example, the recess on the optical sensor 335 can be defined as a circular recess having a radius longer than 10 mm. In addition, an edge of the recess can be as high as the keys of the key unit. It will be appreciated that the cursor pointing unit is not limited to the disclosed design, and can be practiced as various shapes.

The mechanical control stick 331 and buffer cap 333 of FIG. 3 are similar to mechanical control stick 131 and buffer cap 133. Therefore, details are not repeated here.

The buffer cap 133 is positioned between the mechanical control stick 131 and the optical sensor 135. The buffer cap 133 is made of rubber or other electrometric materials. The optical sensor 135 can be embedded in the rubber.

The optical sensor 135 can be implemented by optical finger navigation (OFN) module. The contact surface of the optical sensor 135 is provided for detecting finger movements. These finger movements are then translated into movement of a cursor. The optical sensor 135 comprises: a radiation source for producing a beam of radiation; a sensor for receiving an image; and an optical element for identifying movement of an object on the contact surface to thereby enable a control action to be carried out. According to this embodiment, if the object (finger) is moving at a speed lower than a threshold, the finger movement is translated to movement of a cursor displayed on a screen; if the object (finger) is moving at a speed higher than the threshold, the finger movement is translated into commands directing page navigation on a screen.

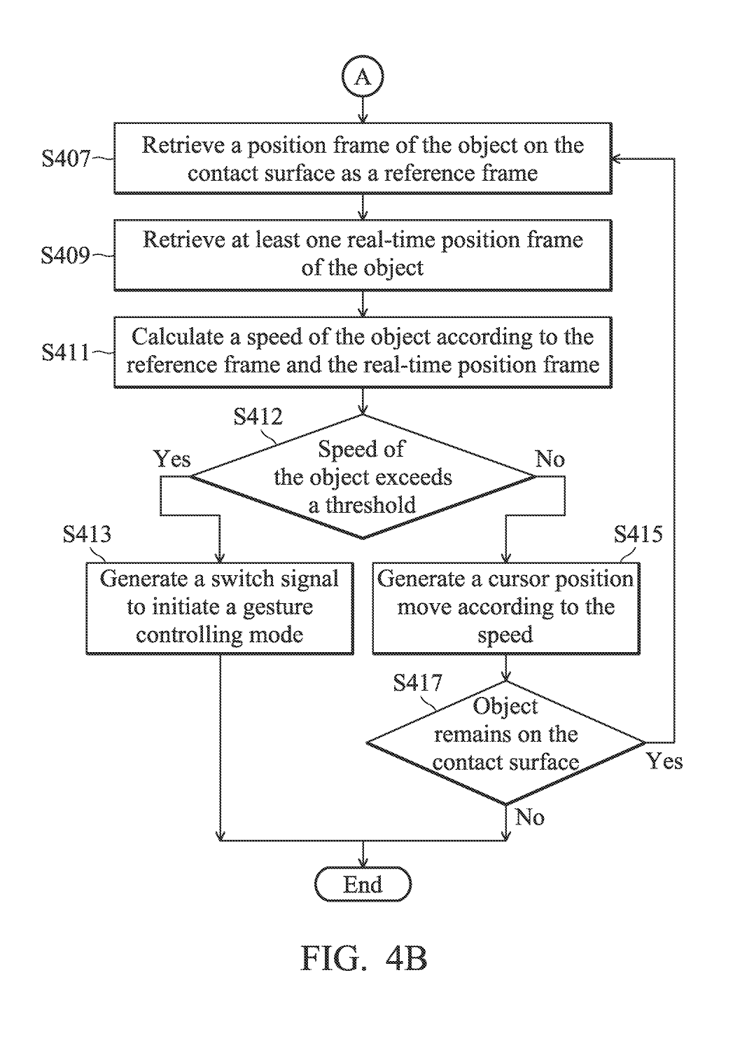

FIG. 4A and FIG. 4B illustrate a flowchart of a method according to an exemplary embodiment. The method illustrated in FIGS. 4A and 4B are implemented by the cursor pointing unit of FIG. 1. The disclosed method is suitable for laptop computer 100 and other portable electronic devices.

Referring to FIG. 4A and FIG. 4B, in step S401, the optical sensor detects movements of an object (such as a finger) across the contact surface of the cursor pointing unit.

In step S403, upon detecting an object on the contact surface, it is determined whether the mechanical control stick is inclined by an exerted pressure, and if so, the method proceeds to step S405, otherwise the method proceeds to step S407.

In step S405, when the mechanical control stick is inclined by an exerted pressure, a cursor signal is generated in order to manipulate position and movement of a cursor displayed on a screen (not shown). The cursor position and cursor movement is manipulated according to magnitude and direction of the pressure exerted on the cursor pointing unit.

In step S407, when the mechanical control stick is not inclined, a position frame of the object on the contact surface is retrieved as a reference frame. The reference frame is used as a basis for determining direction and distance of movements of the object on the contact surface.

In step S409, when the object remains on the contact surface, at least one real-time position frame of the object is retrieved.

In step S411, a speed of the object is calculated according to the reference frame and the real-time position frame. More specifically, direction, distance, and speed of movement of the object is calculated based on a initial position of the object in the reference frame and a new position of the object in the real-time position frame.

In step S412, it is determined whether the speed of the object exceeds a threshold, and if so, the method proceeds to step S413, otherwise the method proceeds to step S415.

In step S413, when the speed exceeds the threshold, a switch signal is generated to initiate a gesture controlling mode, and in response, the laptop computer executes an operation according to received gesture. For example, when finger slides through the contact surface, a swipe gesture is received. For example, in response to the swipe gesture, a screen of the laptop computer is navigated to a previous page or a next page.

In step S415, when the speed does not exceed a threshold, a cursor position move is generated according to the speed. In response to the cursor position move, a cursor displayed on a screen (not shown) is moved accordingly.

In step S417, it is determined whether the object remains on the contact surface, and if so, the method returns to step S407 to retrieve a new reference frame, otherwise, the method ends.

Exemplary operations based on the disclosed method are provided.

First, an operation for fast cursor movement can be executed when a user exerts pressure (for example, pushes or pulls) on the mechanical control stick of the cursor pointing unit. Speed of the cursor movement differs in response to magnitude of the exerted pressure, i.e., inclination of the mechanical control stick. More specifically, the cursor moves at a higher speed in response to a greater inclination angle of the mechanical control stick.

Second, an operation for fine cursor movement can be executed when a user slightly moves his finger on the contact surface of the optical sensor of the cursor pointing unit. For example, when a user wants to adjust an insertion point between characters shown on a screen, he moves his finger slightly on the contact surface of the optical sensor of the cursor pointing unit. The optical sensor is sensitive for finger movement. In addition, this operation will not cause finger fatigue.

Third, an operation translated from a per-defined finger gesture can be executed. For example, when a user slides his finger through the contact surface, a screen of the laptop computer is navigated to a previous page or a next page.

In addition, point-and-click actions can be conducted through the disclosed cursor pointing unit. For example, a single click is conducted when a user hits the contact surface with a quick light blow; while a double click is conducted when a user hits the contact surface with two quick light blows.

As described, according to the disclosed cursor pointing unit, the mechanical control stick is used for executing fast and long-distance cursor movement; and the optical sensor is used for executing fine cursor movement. In addition, operating the cursor pointing unit will not cause finger fatigue.

In addition, the disclosed cursor pointing unit can receive finger gesture, and an operation translated from a per-defined finger gesture can be executed accordingly.

According to the disclosed embodiment, the cursor pointing unit is implemented by a special key equipped in a general keyboard. However, it will be appreciated that the invention is not limited to this embodiment. For example, the cursor pointing unit can be implemented in a space key of a general keyboard.

In addition, the images and other signals received by the optical sensor and the mechanical control stick can be processed by two separated processors or one shared processor. Processing of the images and other signals received by the optical sensor and the mechanical control stick can be performed by a specialized processor or by a central processing unit (CPU) of an electronic device associated with the disclosed cursor pointing unit.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An input device, comprising:
a key unit comprising a plurality of keys;
a cursor pointing unit, comprising:
a mechanical control stick, comprising an upper end and a lower end, wherein the lower end is attached to the key unit;
an optical sensor mounted on the upper end of the mechanical control stick, wherein the optical sensor has a contact surface for sensing object motion thereon; and
a controlling unit configured to perform steps of:
upon detecting an object on the contact surface, determining whether the mechanical control stick is inclined by an exerted pressure;
generating a cursor signal when the mechanical control stick is inclined by an exerted pressure;
when the mechanical control stick is not inclined, retrieving a position frame of the object on the contact surface as a reference frame, and retrieving a real-time position frame of the object when the object remains on the contact surface;
calculating a speed of the object according to the reference frame and the real-time position frame;
when the speed does not exceed a threshold, generating a cursor position move according to the speed; and when the speed exceeds the threshold, generating a switch signal to initiate a gesture controlling mode.

2. The input device as claimed in claim 1, wherein the controlling unit determines and outputs a cursor movement signal when the mechanical control stick is inclined by an exerted pressure.

3. The input device as claimed in claim 1, wherein the mechanical control stick is used for executing fast and long-distance cursor movement.

4. The input device as claimed in claim 1, wherein the optical sensor is used for executing fine cursor movement.

5. The input device as claimed in claim 1, wherein the controlling unit directs a screen to show a different page when the speed of the object exceeds the threshold.

6. The input device as claimed in claim 1, wherein upon detecting the object on the contact surface and receiving a scancode corresponding to a key being pressed, the controlling unit receives a click signal corresponding to the scancode.

7. The input device as claimed in claim 1, wherein the controlling unit receives a click signal when a downward vertical pressure is exerted on the cursor pointing unit.

8. A portable electronic device comprising a keyboard device, a screen device and a computing device, wherein:
the keyboard device comprises:
a key unit comprising a plurality of keys; and
a cursor pointing unit, comprising a mechanical control stick and an optical sensor mounted on the upper end of the mechanical control stick, wherein the mechanical control stick comprises an upper end and a lower end, the lower end is attached to the keyboard; and the optical sensor has a contact surface for sensing object motion thereon;
the computing device configured to perform steps of:
upon detecting an object on the contact surface, determining whether generating a cursor signal when the mechanical control stick is inclined by an exerted pressure;
when the mechanical control stick is not inclined, retrieving a position frame of the object on the contact surface as a reference frame, and retrieving a real-time position frame of the object when the object remains on the contact surface;
calculating a speed of the object according to the reference frame and the real-time position frame;
when the speed does not exceed a threshold, generating a cursor position move according to the speed; and when the speed exceeds the threshold, generating a switch signal to initiate a gesture controlling mode.

9. The portable electronic device as claimed in claim 8, wherein the computing device determines and outputs a cursor movement signal when the mechanical control stick is inclined by an exerted pressure.

10. The portable electronic device as claimed in claim 8, wherein the computing device executing fast and long-distance cursor movement according to inclination of the mechanical control stick.

11. The portable electronic device as claimed in claim 8, wherein the computing device executing fine cursor movement according to detected object movement on the contact surface on the optical sensor.

12. The portable electronic device as claimed in claim 8, wherein the computing device directs the screen device to show a different page when the speed of the object exceeds the threshold.

13. The portable electronic device as claimed in claim 8, wherein, upon detecting the object on the contact surface and receiving a scancode corresponding to a key being pressed, the computing device receives a click signal corresponding to the scancode.

14. The portable electronic device as claimed in claim 8, wherein the computing device receives a click signal when a downward vertical pressure is exerted on the cursor pointing unit.
